(19) United States
(12) Patent Application Publication
(10) Pub. No.: US 2014/0012625 A1
(43) Pub. Date: Jan. 9, 2014

(54) Market Positioning System

(71) Applicant: TATA CONSULTANCY SERVICES LIMITED, Mumbai (IN)

(72) Inventor: Soumen Ray, Bangalore (IN)

(21) Appl. No.: 13/906,693

(22) Filed: May 31, 2013

(30) Foreign Application Priority Data
Jul. 5, 2012 (IN) 1951/MUM/2012

(51) Int. Cl. G06Q 30/02

(52) U.S. Cl. CPC G06Q 30/0202
USPC 705/7.31

(57) ABSTRACT

System(s) and method(s) for market positioning of a plurality of similar products of a plurality of competing brands are described herein. In one implementation, the method includes processing market data of the plurality of similar products of the plurality of competing brands to obtain a volumetric dataset. The method further includes creating one or more models based on the volumetric dataset to estimate parameters, wherein the parameters are indicative of at least one of cross demand elasticity, brand switching and share switching among the plurality of similar products of the plurality of competing brands. The method also includes simulating the one or more models to generate an output indicative of the market positioning of the plurality of similar products of the plurality of competing brands.

### TECHNICAL FIELD

The present subject matter relates, in general, to marketing research, and particularly, but not exclusively, to market positioning of a plurality of similar products of a plurality of competing brands.

### BACKGROUND

Product manufacturers and retailers have been involved with a variety of marketing strategies to sell their products. For purposes of this application, “manufacturers” include manufacturers, distributors, suppliers, brokers and vendors of products such as consumer packaged goods. For purposes of this application, “retailers” include retailers and other businesses which sell products such as consumer packaged goods on a wholesale or retail basis to customers or consumers, e.g., supermarkets, mass merchandisers and chain drug stores.

As more and more consumers become brand conscious across the globe, manufacturers and retailers consistently strive towards enhancing the value of demand oriented brands. Enormous efforts are spent in conducting market research to study relative position of products among competing brands in a market and further identifying competitive structure among different brands. Study of the market and analysis of a relative position of a brand with respect to other brands in the market, allows the manufacturers and retailers to devise strategies for positioning brands effectively and align their marketing strategies with their short or long term plans.

Marketing strategies commonly include instruments, such as brand promotion to increase customer loyalty, awareness of products, and sales. Instead of focusing on a specific product or products, the manufacturers and retailers instead focuses on promotion of brand. Brand promotions may include price promotions, display and internet advertisements, print advertisements etc. Brand promotions may affect the market of a particular brand of a product. The effect of brand promotions and other marketing strategies for a brand is evaluated and analyzed, by companies, market researchers, store owners, and manufacturers in order to infer an impact of these strategies and further improving the decision making process.

### SUMMARY

This summary is provided to introduce concepts related to market positioning of a plurality of similar products of a plurality of competing brands, which are further described below in the detailed description. This summary is neither intended to identify essential features of the claimed subject matter nor is it intended for use in determining or limiting the scope of the claimed subject matter.

System(s) and method(s) for market positioning of a plurality of similar products of a plurality of competing brands are described herein. In one implementation, the method includes processing market data of the plurality of similar products of the plurality of competing brands to obtain a volumetric dataset. The method further includes creating one or more models based on the volumetric dataset to estimate parameters, wherein the parameters are indicative of at least one of cross demand elasticity, brand switching and share switching among the plurality of similar products of the plurality of competing brands. The method also includes simulating the one or more models to generate an output indicative of the market positioning of the plurality of similar products of the plurality of competing brands.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a networking environment implementing a market positioning system, in accordance with an embodiment of the present subject matter.

FIG. 1(a) illustrates own and cross demand elasticity graphs obtained as an output of the market positioning system, accordance with an embodiment of the present subject matter.

FIG. 2 illustrates a method for market positioning of a plurality of similar products of a plurality of competing brands, according to one embodiment of the present subject matter.

### DETAILED DESCRIPTION

The present subject matter relates to method(s) and system(s) employing marketing research for market positioning of a plurality of similar products of a plurality of competing brands in a consumer store like supermarkets, malls, shopping centre etc. In one embodiment, the present subject matter provides for determining competitive positioning of competing brands with respect to each other in a category of products. Further in accordance with another embodiment of the present subject matter, the method(s) and system(s) enable evaluation of share switching and demand elasticities among the similar products of the plurality of competing brands.

Assessing current position of a brand with respect to its competitors is important for companies, market researchers, store owners and manufacturers to plan their marketing strategies. Marketing strategies include various types of brand promotions. Brand promotions, for example, have become an important tool in today's sales and marketing industry for companies and ventures to increase sales of a particular product and build customer loyalty for their respective brands compared to other competing brands existing in a market and offering the similar product. Brand promotions have evolved from mouth publicity and paper pamphlets to complex techniques such as price promotions, display advertisements, internet promotions, and the like. Brand promotions may have either a long term impact or a short term impact on the sales of the competing brands. An impact of brand promotions on the sales of the brands is termed as a long term impact if the sales are affected even after the brand promotions are discontinued. On the other hand, if the sales are no longer affected after the brand promotions are discontinued, then the impact is termed as a short term impact.

Generally, the impact of brand promotions, herein interchangeably referred to as promotions, on sales and on market share of the brands may be evaluated and analyzed in order to get an estimate of how the promotions affect different brands of a particular or similar product for a fixed period of time. The effect of the promotions on the brands may be negative or positive in nature. If the sales of a brand increase, then the effect of the promotions may be deemed as a positive effect whereas, if the sales of a brand decrease, the effect may be deemed as a negative effect.

Generally, products such as electronic goods, clothing, footwear, eatables and the like have sales vulnerable to promotions and other factors, such as change in price, availability, and environmental factors. For example, for goods such as televisions, the sales may decrease if there is an increase in a world market price of televisions. Further, in another example, the sales of televisions may increase when a major worldwide sporting event is being held. Also, sales of poultry products may increase if a worldwide health report is issued regarding the benefits of the poultry products, and the sales of poultry products may decrease on account of a disease spread related to them, for example, say swine flu.

Conventionally, for products with vulnerable sales, various econometric methods are applied in order to assess their competitive positioning in the market and to infer the impacts of the promotions on them. The competitive positioning and impact of the promotions for such brands may be determined by various conventional modeling techniques. Typically, these conventional modeling techniques involve formulating a time series of the sales of these brands over a period of time and evaluating the time series by econometric methods, such as correlation, regression etc.

Conventional systems employing such modeling techniques are useful to sketch competitive structures among the plurality of competing brands. The conventional systems provides the knowledge of increase or decrease in the sales for a category of products of competing brands by providing statistical information like inventory evaluations, own demand elasticities, market share, future forecasted values etc. Although effective, these conventional systems lack crucial aspects, such as, brand-switching, share-switching, and cross demand elasticities.

For example, consider weekly sales of a particular or similar product of two brands X and Y in a store where same number of households visits each week. Further, if the price of, say, brand X is lowered in a certain week then sales of brand X may increase and that of brand Y may decrease. This information is useful to see if lower prices generate more sales, but it is insufficient to understand whether change in sales of brand X can be fully attributed to households who change from brand Y to brand X. Hence, conventional systems are incapable of addressing from where the new sales come from by simply looking at weekly sales and share data.

The system according to the present subject matter employs a method to identify competitive positioning among the plurality of competing brands as brand-switching, evaluate cross and own demand elasticities and further determining share-switching among the plurality of competing brands on the basis of widely available store level data. The store level data pertains to promotional data, sales and market share data of the plurality of competing brands obtained from various consumer stores like supermarkets, malls, shopping centre etc. Share-switching among the plurality of competing brands is related to aggregate market shares in a similar fashion as brand-switching is related to individual brand choice behavior.

Further the system according to the present subject matter helps in better understanding of the competitive structure by analyzing the share-switching among the plurality of competing brands which is not provided by the conventional systems. For example, consider two brands A and B. It might happen that cross price elasticities suggest that A and B are not strong price competitors, while at the same time much share switching does occur between these two brands. In that case, competition between A and B might be due to low customer loyalty for both brands. An explanation for such a competition is that households might derive utility from brand-switching itself, besides the utility resulting from the selected brand. In this case, increasing customer loyalty should be more important than pricing strategies. Such an inference makes the decision making process simpler and efficient.

System(s) and method(s) employing marketing research models for market positioning of a plurality of similar products of a plurality of competing brands in a consumer store like supermarkets, malls, shopping centre etc., are described herein. The present subject matter provides for determining positioning of competing brands with respect to each other in a category of products. Further in accordance with another embodiment of the present subject matter, the method(s) and system(s) enable evaluation of share-switching and evaluation of own and cross demand elasticities among the plurality of similar products of the plurality of competing brands.

In one embodiment, the share-switching among the plurality of similar products of the plurality of competing brands may be determined by receiving product data pertaining to the plurality of competing brands. The plurality of competing brands may be understood as brands whose sales cumulatively contribute to the overall consistent brand sales for a given product or product category in a particular market. The product data may be based on historical sales and promotion data and other forecasting tools. In an example, the historical data may include data pertaining to yearly sales, amount invested in promotions, amount of products manufactured, increase or decrease in price, and the like.

In an embodiment, the product data obtained is further optimized using econometric methods. In one example, the econometric methods converts the product data pertaining to the plurality of competing brands into stock keeping units (SKUs) representing a percentage of sales for each of the plurality of competing brands. SKU refers to an unique identifier for each distinct product and service that can be purchased in business. The SKUs may be identified in order to estimate impacts of promotional variables on each of the plurality of competing brands for a fixed period of time.

Further, the SKUs and the impact of promotional variables may be represented as a functional equation. Subsequent to the representation, modeling of the functional equation is performed using Markov equations, Logit model of McFadden, Vector Error Correction Modeling (VECM) etc. to obtain equations and parameters identifying market analysis of the plurality of competing brands. The market analysis includes generating a market share attraction model, a market share gain/loss model, a market share-switching model, etc., to identify the market positioning.

In an implementation, the brand switching among the plurality of competing brands may be depicted in a brand competitive positioning matrix. For example, the SKUs and the impact of promotional variables that are indicative of a relationship between the increase or decrease in the sales of a brand with respect to the increase and decrease in the sales of a competing brand may be depicting in the brand competitive positioning matrix. Based on the brand competitive positioning matrix, the relationship of the sales of two or more competing brands, based on the promotions, may be analyzed.

Further in an implementation, the share-switching among the plurality of competing brands may be depicted in a percentage share gain or percentage share loss relationship. The relationship, for example, may include Gain-Gain relationship, Gain-Loss Relationship, Loss-Gain relationship, and the like. The share-switching analyses aides the manufacturers and retailers in identifying factors other than promotional variables affecting a brand's competitive position in the market. The factors may include consumer loyalty, environmental factors, personal issues of the consumer etc.

Further in one implementation, the elasticity measures among the plurality of competing brands may be depicted as a graphical scale analysis of market share of each of the plurality of competing brands with respect to a time period in comparison to other competing brands. Also, own and cross demand elasticities measures may be depicted as a graphical representation of a brands attributes in comparison to the attributes of the plurality of competing brands. The elasticity measures aides the manufacturers and retailers in identifying factors that measure the responsiveness of a brands sales and market share to different market conditions.

The above method(s) and system(s) are further described in conjunction with the following figures. It should be noted that the description and figures merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and the concepts contributed by the inventor(s) to furthering the art, and are to be construed as being without limitation to such specifically recited examples and conditions. Moreover, all statements herein reciting principles, aspects, and embodiments of the present subject matter, as well as specific examples thereof, are intended to encompass equivalents thereof.

It will also be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action. Additionally, the word “connected” is used throughout for clarity of the description and can include either a direct connection or an indirect connection.

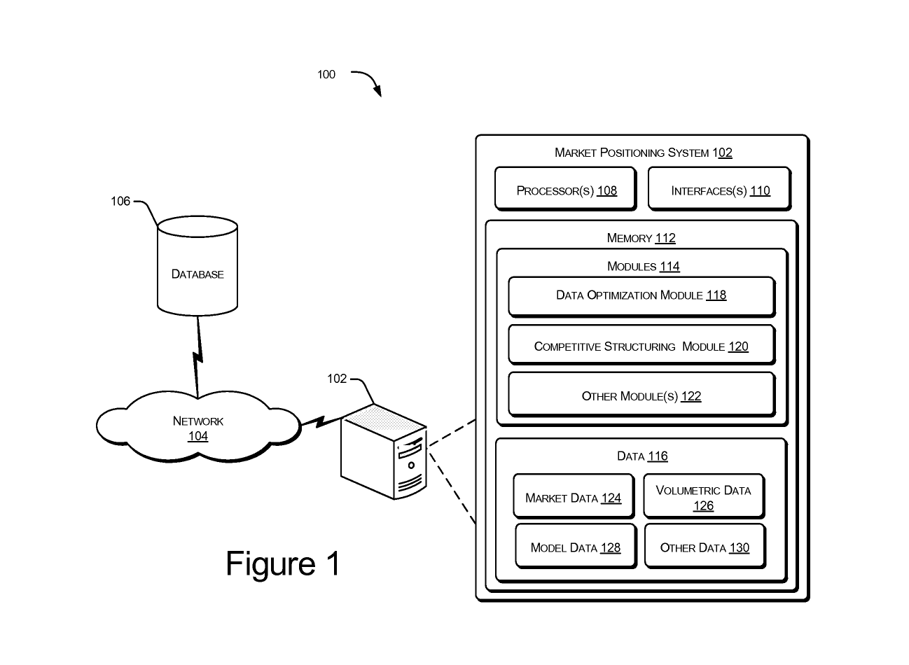

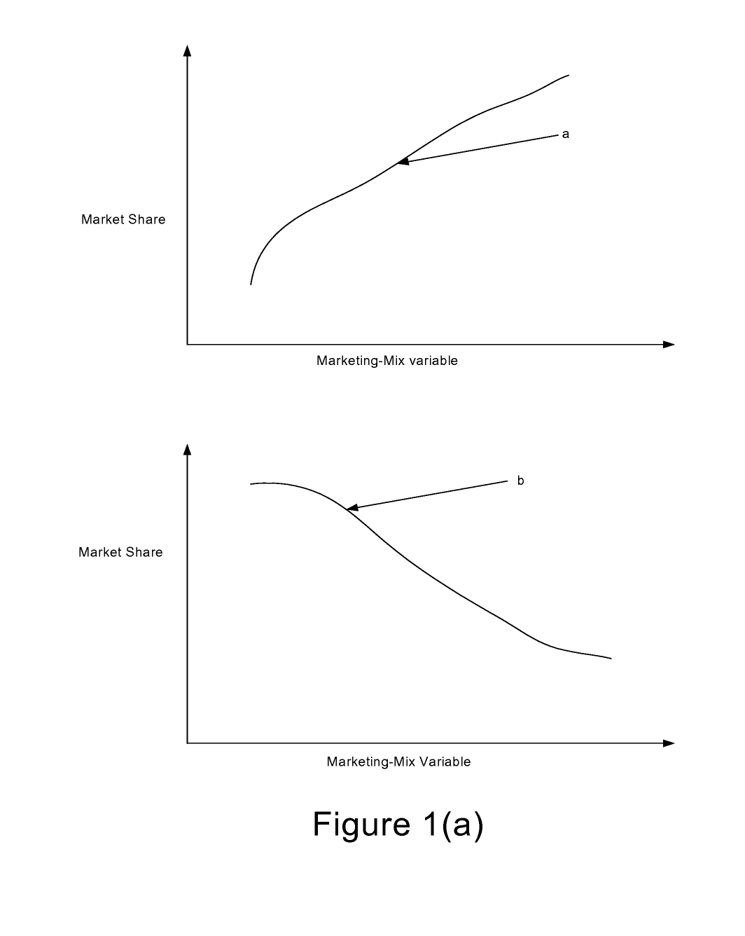

FIG. 1 illustrates a network environment 100 implementing a Market Positioning System 102, according to an embodiment of the present subject matter. The Market Positioning System 102, hereinafter referred to as the MP system 102, is configured for market positioning of a plurality of similar products of a plurality of competing brands in a database 106. The market positioning is defined as relative positioning of the plurality of similar products of the plurality of competing brands in respect of their sales, market share, brand and share switching, and own and cross demand elasticities.

The MP system 102 over a network 104 is communicatively coupled to a database server 106, hereinafter referred to as the database 106. The MP system 102 may be implemented in a computing device, such as a hand-held device, a laptop or other portable computer, a tablet computer, a mobile phone, a PDA, a smartphone, and a desktop computer. The MP system 102 may also be implemented in a workstation, a mainframe computer, a server, and a network server. Further, although FIG. 1 depicts only one database 106, in an implementation, the MP system 102 may be communicatively coupled to more than one database for the purpose of the market positioning of a plurality of similar products of a plurality of competing brands.

The network 104 may be a wireless or a wired network, or a combination thereof. In an example, the network 104 can be implemented as a computer network, as one of the different types of networks, such as intranet, local area network (LAN), wide area network (WAN), the internet, and such. The network 104 may either be a dedicated network or a shared network, which represents an association of the different types of networks that use a variety of protocols, for example, Hypertext Transfer Protocol (HTTP), Transmission Control Protocol/Internet Protocol (TCP/IP), and Wireless Application Protocol (WAP), to communicate with each other. Further, the network 104 may include a variety of network devices, including routers, bridges, servers, computing devices, storage devices. The network devices within the network 104 may interact with the MP system 102 and the database 106 through communication links.

In another example, the network 104 can be implemented as a telecommunication network. In said example, the network 104 can be a collection of individual networks, interconnected with each other and functioning as a single large network (e.g., the internet or an intranet). Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), IP-based network, Public Switched Telephone Network (PSTN), and Integrated Services Digital Network (ISDN). Depending on the technology, the network 104 includes various network entities, such as gateways, routers; however, such details have been omitted for the sake of brevity. Further, in an example, the MP system 102 can use General Packet Radio Service (GPRS) or Bluetooth for communicating with the database 106. In yet another example, the network 104 can be implemented as a combination of a computer network as well as a telecommunication network.

In an implementation, the MP system 102 includes one or more processor(s) 108, interface(s) 110, and a memory 112 coupled to the processor(s) 108. The interface(s) 110 may include a variety of software and hardware interfaces, for example, interfaces for peripheral device(s), such as a keyboard, a mouse, an external memory, a camera device, and a printer. Further, the interface(s) 110 may enable the MP system 102 to communicate with other devices, such as web servers and external databases. The interface(s) 110 can facilitate multiple communications within a wide variety of networks and protocol types, including wired networks, for example, local area network (LAN), cable, etc., and wireless networks, such as Wireless LAN (WLAN), cellular, or satellite. For the purpose, the interface(s) 110 may include one or more ports for connecting a number of computing systems with one another or to another server computer.

The processor(s) 108 can be a single processing unit or a number of units, all of which could include multiple computing units. The processor 108 may be implemented as one or more microprocessors, microcomputers, microcontrollers, digital signal processors, central processing units, state machines, logic circuitries, and/or any devices that manipulate signals based on operational instructions. Among other capabilities, the processor 108 is configured to fetch and execute computer-readable instructions and data stored in the memory 112.

The memory 112 may include any non transitory computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 112 also includes modules 114 and data 116.

The modules 114, amongst other things, include routines, programs, objects, components, data structures, etc., which perform particular tasks or implement particular abstract data types. In an implementation, the modules 114 further include a data optimization module (DOM) 118, a competitive structuring module (CSM) 120, and other module(s) 122. The other modules 122 may include programs that supplement applications on the MP system 102, for example, programs in the operating system. On the other hand, the data 116 serves, amongst other things, as a repository for storing data processed, received, and generated by one or more of the modules 114. In an implementation, the data 116 includes market data 124, volumetric data 126, model data 128, and other data 130. The other data 130 includes data generated as a result of the execution of one or more modules in the other modules 122.

In an implementation, a user may access the MP system 102 for the purpose of market positioning of the plurality of similar products of the plurality of competing brands in the database 106. For the purposes of the description herein, the user may be understood as a professional who has skills and capability of operating the MP system 102. In an implementation, the user may be a manufacturer, distributor, supplier, broker, researcher and vendor etc. who is authorized to access the MP system 102. In an implementation, the user is provided with a user interface, such as a graphic user interface (GUI), which may be used for the purposes of market positioning of the plurality of similar products of the plurality of competing brands in the database 106.

In one implementation, the MP system 102 receives product data corresponding to sales, market share, and promotions of the plurality of similar products of the plurality of competing brands. In an implementation, the MP system 102 may receive the product data from the database 106 associated with the MP system 102. The product data may include historical sales and market share over a fixed period of time for the plurality of similar products of the plurality of competing brands. The historical sales and the market share, in an example, may include yearly, monthly or weekly sales and share of a particular market the plurality of similar products of the plurality of competing brands. In another example, the historical sales and the market share may further include region wise, quarter wise, and/or consumer group wise sales and share. The promotions may include year wise promotion data, region wise promotion data, consumer group wise promotion data, and the like. Further, the database 106 associated with the MP system 102 may have stored data related to share markets, stock exchanges, annual reports of various companies and the like. The product data corresponding to the sales, the market share, and the promotions of the plurality of similar products of the plurality of competing brands when received by the MP system 102, may be stored in the MP system 102 as the market data 124. In an example the product data corresponding to the sales of a brand A may be as shown in table 1 below:

TABLE 1

| Time (weeks) | Brand A sales |
|---|---|
| 1114 | 76892 |
| 1115 | 87168 |
| 1116 | 200603 |
| 1117 | 159511 |
| 1118 | 119724 |
| 1119 | 89636 |
| 1120 | 117921 |

In a similar way, data pertaining to market share and promotions corresponding to brand A may also be obtained. Further, similarly, the data pertaining to the sales, the market share, and the promotions corresponding to other brands may also be obtained.

Subsequent to the receiving of the market data 124 by the MP system 102, the DOM module 118 processes the market data 124 of the plurality of similar products of the plurality of competing brands received by the MP system 102 into Stock Keeping Units (SKU's). In an implementation, the DOM module 118 may be configured to formulate the SKU's based on the market data 124, for example, based on any conventional mathematical tool. In accordance with one embodiment of the present subject matter, the SKU's may be formulated as follows.

The market data 124 pertaining to the sales, the market share and the promotions for each of the plurality of similar products of the plurality of competing brands is classified on a percentage scale. In an implementation, the percentage scale is divided in the ratio 85%-15% to obtain the SKU's. In an example, the brands constituting 85% of the sales, 85% of the market share, 85% of the promotions forms an SKU and the brands constituting 15% of the sales, 15% of the market share, and 15% of the promotions forms another SKU.

In an implementation, the DOM module 118 is further configured to evaluate a base price (BP), average price (AP) and temporary price reduction (TPR) for each of the plurality of competing brands. The BP is evaluated as a price falling within 10% range of maximum price using a moving average forecasting method over a two weeks time. The AP is evaluated as a ratio of total price to total sales. Further, the TPR is determined as the difference between the BP and the AP.

In an implementation, the DOM module 118 is further configured to create a volumetric data set for the SKU's, the BP, and the TPR. The volumetric data set for the SKU's, the BP, and the TPR is created as a .CSV or SAS datasets for further modeling. Further, the data pertaining to the SKU's, the BP, the TPR, and the volumetric data set for the SKU's, the BP, and the TPR as optimized in the MP system 102, may be stored in the MP system 102 as the volumetric data 126. For example, the volumetric dataset for a brand A is represented in table 2 below.

TABLE 2

| | | | | | | Size of |
|---|---|---|---|---|---|---|
| Product | Week | Volume | No. of Packs | Promotion | Price/Pack | Pack |
| Alpha 1 | 1 | 150 ml | 1 | No | 1.9 | 150 ml |
| Alpha 2 | 1 | 175 ml | 1 | 20% off | 2.28 | 175 ml |

Further, as shown there are two different products under brand A i.e., Alpha 1 and Alpha 2 having different data. To obtain single data pertaining to brand A, the data for the individual products is merged to obtain a volumetric data for brand A. For example, a volumetric price for brand A can be evaluated as follows:

Volumetric Price of Brand A=Total volume of the products/Total Price=(150+175)/(1.9+2.28)

In a similar way, volumetric data sets for each of the plurality of competing brands may be obtained.

In an implementation, the CSM module 120 is configured for modeling of the volumetric data set of the volumetric data 126. The modeling of the volumetric data set is done to evaluate competitive positioning, market share, brand switching, share switching, and own and cross demand elasticities among the plurality of similar products of the plurality of competing brands using tools like econometric time series, market share attraction model, share gain and loss model, and Logit model of McFadden. The models as mentioned are used to estimate marketing-mix response parameters and variance parameters.

In one implementation, the market positioning of the plurality of similar products of the plurality of competing brands is done by the CSM module 120 using econometric time series modeling of data pertaining to the sales, the market share, and the promotions. In one implementation, the formulation of the econometric time series for the plurality of competing brands is based on equation (1) as follows:

x [symbol] ={x₀x₁x₂ . . . x_{T}} t=0,1,2, , , , T (1)

Wherein, xₜ represents a general time series function and t represents time periods for analyzing the trend of the time series function. The econometric time series as obtained for brand A may be represented as x_{At}. In a similar way, other brands may also be represented. The econometric time series obtained for each of the plurality of competing brands is statistically analyzed by tools like correlation, regression, or cointegration to obtain the competitive positioning of the plurality of competing brands.

The CSM module 120 is further configured to identify share switching among the plurality of competing brands through a share switching matrix and a share gain-loss matrix. In an implementation, the share switching matrix is identified following the Logit model of McFadden, the market share attraction model, and the share gain and loss model. In an example, the Logit model of McFadden is represented as equation (2) below:

$${δ}_{AB} = \frac{\{ exp ( {α}_{AB} + β * ( {x}_{Bt} - {x}_{B ( t - 1 )} ) \}}{{\sum }_{B = 1}^{n} \{ exp ( {α}_{AB} + β * ( {x}_{Bt} - {x}_{B ( t - 1 )} ) \}} \qquad ( 2 )$$

Where, δ_{AE} represents an element in the share switching matrix where changes in share occurs from brand A to brand B. α_{Aδ} represents an intercept parameter estimate and β represents parameter estimate of marketing-mix variable x for brand B between two successive time intervals. The marketing-mix variable may include price, discounts, advertising, internet, banners etc. promotional variables. In a similar way, modeling for each of the plurality of competing brands is done.

Further, the market share attraction model is represented as equation (3) below:

$${α}_{A , t} = exp ( {α}_{A} + {\sum }_{s = 1}^{S} {\sum }_{B = 1}^{n} {β}_{( s ) B , A} ln ( {x}_{( s ) B , t} ) + {ɛ}_{A , t} ) \qquad ( 3 )$$

The above expression represents attraction of brand A at time t. α_{A} is a brand specific intercept, x_{(s)Bx} is the value of marketing-mix variable s for brand B at time t. In an example, s varies from 1, 2 . . . S; where s=1 corresponds to price, s=2 corresponds to display and so on. β [symbol] is the involved response parameter, and [symbol] is a disturbance term. In a similar way, modeling for each of the plurality of competing brands is done.

In an implementation, the CSM module 120 evaluates the market share for each of the plurality of competing brands in proportion to market share attraction as equation (4) below:

$${MS}_{A , t} = {α}_{A , t} / {\sum }_{B = 1}^{n} {α}_{B , t} \qquad ( 4 )$$

Further, the CSM module 120 is configured to evaluate share gain and loss model for each of the plurality of competing brands as equation (5) and (6) below:

$$\begin{matrix}ln L = - \frac{m - 1}{2} * ( ln ( 2 π ) + ln ( {σ}^{2} ) ) + \frac{{\sum }_{t = 2}^{T} log det ( {P}_{t}^{- 1} )}{2} - \frac{{\sum }_{t = 2}^{T} ( Q ( {P}_{t}^{- 1} ) )}{2 {σ}^{2}} , \\ & ( 5 ) \\ {P}^{- 1} = ( \frac{1}{{MS}_{sum ( lag \_ two \_ plus {\_γ}_{1} ) t}} ) * ( ( ( {MS}_{( lag \_ - {γ}_{2} ) t} ( m - 1 ) ) * {I}_{( m - 1 ) , ( m - 1 )} + diag ( {MS}_{( lag \_ - {γ}_{2} ) t} ( m - 2 ) ) ) & ( 6 )\end{matrix}$$

Where, L is a likelihood function, m corresponds to number of brands, σ² and γ are variance parameters, and Pₜ corresponds to the negative correlation among the market shares of the plurality of competing brands. The negative correlation is interpreted as, by definition, a larger market share for one brand results in a smaller market share for all other brands. In a similar way, modeling for each of the plurality of competing brands is done.

Further in an implementation, the CSM module 102 evaluates own and cross demand elasticities for the plurality of competing brands as relations (7) and (8) are shown for brand A below:

(Own elasticity)_{A}=(Change in share of brand A)/(Changes in marketing-mix of brand A) (7),

(Cross elasticity)_{A}=(Change in share of brand A)/(Changes in marketing-mix of brand B) (8)

In a similar way, modeling for each of the plurality of competing brands is done. Further, the data pertaining to the share switching among the plurality of competing brands as obtained from the above mentioned models, may be stored in the MP system 102 as the model data 128.

The CSM module 120 further simulates the model data 128 on the basis of the estimated marketing-mix response and variance parameters, and further evaluates the competitive positioning matrix, the share switching matrix incorporated with the share gain-loss matrix as shown below in table 3 and table 4 respectively, and own and cross demand elasticity graphs as shown in FIG. 1a.

In one implementation, the competitive positioning of the plurality of competing brands may be represented as the competitive positioning matrix as shown in table 3 below.

TABLE 3
Competitive positioning matrix

| Brand | A | B | C | D | E |
|---|---|---|---|---|---|
| A | 0.902 | 0.096 | 0.018 | 0 | 0 |
| B | 0 | 0.904 | 0 | 0 | 0.015 |
| C | 0.013 | 0 | 0.982 | 0 | 0 |
| D | 0 | 0 | 0 | 0.802 | 0.104 |
| E | 0 | 0 | 0 | 0.084 | 0.749 |

TABLE 4
Share-Switching Matrix

| | | Brand A | Brand B | Brand C | Brand D | Brand E | Brand F | Brand G | Brand H |
|---|---|---|---|---|---|---|---|---|---|
| Market Share | | 15.09% | 2.40% | 9.08% | 32.36% | 1.09% | 21.28% | 5.10% | 13.61% |
| Week 1 | | | | | | | | | |
| Market Share | | 12.41% | 2.90% | 7.96% | 33.80% | 2.79% | 23.31% | 3.34% | 13.49% |
| Week 2 | | | | | | | | | |
| | | −2.68% | 0.50% | −1.11% | 1.45% | 1.70% | 2.03% | −1.76% | −0.12% |
| Share Loss | Brand A | — | — | — | — | — | −0.18% | −1.3% | — |
| | Brand B | — | −0.04% | — | — | −0.03% | — | — | — |
| | Brand C | — | — | −0.13% | — | — | — | — | — |
| | Brand D | — | — | — | — | −0.07% | — | −1.02% | — |
| | Brand E | — | — | — | −0.52% | — | — | — | — |
| | Brand F | −2.17% | — | — | — | −0.11% | — | — | −1.23% |
| | Brand G | −1.02% | — | — | −0.26% | — | — | — | — |
| | Brand H | — | — | — | — | — | −0.44% | — | — |
| Total Share | | −3.19% | −0.04% | −0.13% | −0.77% | −0.21% | −0.62% | −2.31% | −1.23% |
| Loss | | | | | | | | | |
| Share Gain | Brand A | — | — | 1.2% | — | — | — | — | 0.60% |
| | Brand B | 0.03% | — | — | — | — | — | — | — |
| | Brand C | 0.13% | — | — | — | — | — | — | — |
| | Brand D | — | — | — | — | 2.07% | — | — | — |
| | Brand E | 0.16% | 0.54% | — | 0.07% | — | 0.11% | — | — |
| | Brand F | 0.36% | — | — | — | — | — | 0.78% | — |
| | Brand G | — | — | — | 0.55% | — | 0.78% | — | — |
| | Brand H | — | — | — | — | — | 1.23% | — | — |
| Total Share | | 0.68% | 0.54% | 1.24% | 0.62% | 2.07% | 2.12% | 0.78% | 0.60% |
| Gain | | | | | | | | | |

As mentioned previously, the competitive positioning matrix of table 3 is indicative of brand-switching among the plurality of competing brands i.e., amount of brand-switching occurring among the plurality of competing brands. For example, it can be inferred from table 3 that 1.3% switching occurred from brand A to brand C. Further, the share-switching matrix of table 4 allows determination of a Gain-Gain relationship, Gain-Loss Relationship, or Loss-Gain relationship relation that may exist between the plurality of competing brands. For example, it can be inferred from table 4 that total share loss for brand A is 3.19%, constituting a 2.17% loss to brand F and 1.02% loss to brand G. Also, it can be inferred from table 4 that total share gain for brand A is 0.68%, constituting gain of 0.03%, 0.13%, 0.16% and 0.36% from brand's B, C, E and F respectively. This provides for analysis of the position of a brand with respect to each of the other brand in that category.

FIG. 1(a) illustrates own and cross demand elasticity graphs obtained as an output of the market positioning system 102, accordance with an embodiment of the present subject matter. In FIG. 1a, ‘a’ illustrates a cross demand elasticity graph among a set of two brands of the plurality of competing brands and ‘b’ illustrates an own demand elasticity graph for a brand of the plurality of competing brands. Graphs ‘a’ and ‘b’ are obtained on simulation of relations (7) and (8) mentioned earlier by the CSM module 120. In an implementation, the CSM module 120 processes the market share data and the marketing-mix variables as input to simulate the own and cross demand elasticity graphs for each of the plurality of competing brands.

Although embodiments for the market positioning system 102 have been described in language specific to structural features and/or methods, it is to be understood that the present subject matter is not necessarily limited to the specific features or methods described. Rather, the specific features and methods are disclosed as exemplary implementations for the market positioning system 102.

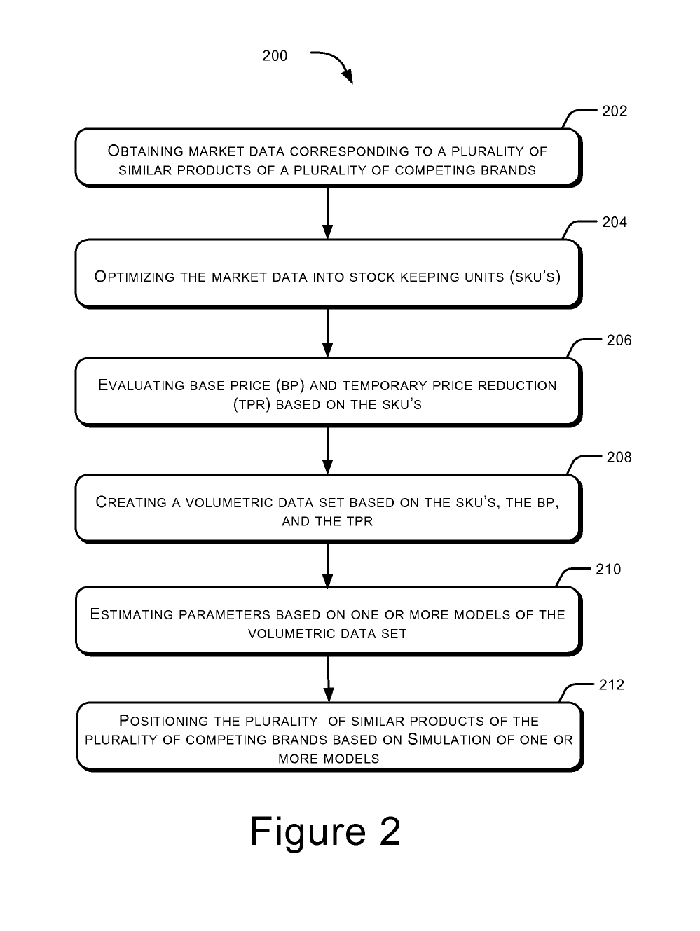

FIG. 2 illustrates a method 200 for market positioning of a plurality of similar products of a plurality of competing brands, in accordance to an embodiment of the present subject matter. The method 200 is implemented in computing device, such as a system. The method 200 may be described in the general context of computer executable instructions. Generally, computer executable instructions can include routines, programs, objects, components, data structures, procedures, modules, functions, etc., that perform particular functions or implement particular abstract data types. The method 200 may also be practiced in a distributed computing environment where functions are performed by remote processing devices that are linked through a communications network.

The order in which the method 200 is described is not intended to be construed as a limitation, and any number of the described method blocks can be combined in any order to implement the method, or an alternative method. Additionally, individual blocks may be deleted from the method without departing from the spirit and scope of the subject matter described herein. Furthermore, the method can be implemented in any suitable hardware, software, firmware, or combination thereof.

At block 202, the method 200 includes obtaining market data corresponding to sales, market share, and promotions of the plurality of similar products of the plurality of competing brands according to an embodiment of the present subject matter. In one example of the method 200 depicted herein, the market data as Brand A sales is received as shown in table 1 earlier. The present example is used only for the purposes of illustration. It will be understood that in various other examples, the market data can be received for any number of brands. The market data corresponding to the sales, the market share, and the promotions of the plurality of competing brands received may be stored as the market data 124.

At block 204, the method 200 includes optimizing the market data 124 pertaining to the sales, the market share and the promotions for each of the plurality of competing brands into SKU's. In one implementation as described earlier, the SKU's are identified based on a percentage scale. In an example, the brands constituting 85% of sales, 85% of share, 85% of promotions forms an SKU and the brands constituting 15% of sales, 15% of share, and 15% of promotions forms another SKU.

At block 206, the method 200 includes evaluating a base price (BP), an average price (AP) and temporary price reduction (TPR) for each of the plurality of competing brands. As described earlier, the BP is evaluated using a moving average forecasting method of the price falling within 10% range of the maximum price over a two weeks time and the AP is evaluated as a ratio of total price to total sales. Further, the TPR is determined as the difference between the BP and the AP.

At block 208, the method 200 includes creating volumetric data set for the SKU's, the BP, and the TPR. As mentioned earlier, the model data set for the SKU's, the BP, and the TPR is created as the .CSV or SAS datasets for further modeling. Further, the data pertaining to the SKU's, the BP, the TPR, and the model data set for the SKU's, the BP, and the TPR may be stored as the volumetric data 126. Further in an example, the volumetric data set for brand A is shown earlier in table 2.

At block 210, the method 200 includes modeling of the volumetric dataset of the volumetric data 126. Further, parameters corresponding to competitive nature of the plurality of competing brands are estimated using tools like econometric time series, market share attraction model, share gain and loss model, and Logit model of McFadden as described earlier. The parameters required to identify the competitive nature of the plurality of competing brands are evaluated from equations (1), (2), (3), (4), (5), (6) and relations (7) and (8) as described earlier. Further, the data pertaining to the competitive nature of the plurality of competing brands as obtained from the above mentioned models, may be stored as the model data 128.

At block 212, the method 200 includes market positioning of the plurality of competing brands based on simulation of the model data 128 obtained in the previous step. In an example, the competitive structuring of the plurality of competing brands is represented as table 3 representing the competitive brand positioning, table 4 representing the share-switching incorporating the share gain/loss for the plurality of competing brands, and own and cross demand elasticity graphs as described earlier.

Although the method 200 for market positioning of a plurality of similar products of a plurality of competing brands has been described referring to certain modeling/simulation techniques, it is to be understood that the subject matter is not necessarily limited to the specific modeling/simulation techniques described. Other modeling/simulation techniques, either existing or that may be developed in future, to perform the same function as the described modeling/simulation techniques can also be used.

I/We claim:

1. A method for market positioning of a plurality of similar products of a plurality of competing brands, the method comprising:
processing market data of the plurality of similar products of the plurality of competing brands to obtain a volumetric dataset;
creating one or more models based on the volumetric dataset to estimate parameters, wherein the parameters are indicative of at least one of cross demand elasticity, brand switching and share switching among the plurality of similar products of the plurality of competing brands; and
simulating the one or more models to generate an output indicative of the market positioning of the plurality of similar products of the plurality of competing brands.

2. The method as claimed in claim 1, wherein the one or models to estimate the parameters includes at least one of Markov equations, Logit model of McFadden, market share attraction model, and share gain and loss model.

3. The method as claimed in claim 1, wherein the output indicative of market positioning comprises at least one of a brand competitive positioning matrix, a share-switching matrix, and own and cross demand elasticity graphs, such that the brand competitive positioning matrix, the share-switching matrix, and the own and cross demand elasticity graphs indicate a relative position of a brand from amongst the plurality of competing brands with respect to another brand from amongst the plurality of competing brands.

4. A market positioning system comprising:
a processor; and
a memory coupled to the processor, the memory comprising:
a data optimization module configured to generate a volumetric dataset based on market data; and
a competitive structuring module configured to:
create one or more models based on the volumetric dataset to estimate parameters; and
simulate the one or more models based on the parameters to generate an output indicative of market positioning of a plurality of similar products of a plurality of competing brands.

5. The market positioning system as claimed in claim 4, wherein the competitive structuring module provides the output as at least one of a brand competitive positioning matrix, a share-switching matrix, and own and cross demand elasticity graphs, such that the brand competitive positioning matrix, the share-switching matrix, and the own and cross demand elasticity graphs indicate a relative position of a brand from amongst the plurality of competing brands with respect to another brand from amongst the plurality of competing brands.

6. The market positioning system as claimed in claim 4, wherein the volumetric dataset created by the data optimization module includes at least one of stock keeping units, base price, average price, and temporary price reduction.
